(19) United States
(12) Patent Application Publication
(10) Pub. No.: US 2020/0104937 A1
(43) Pub. Date: Apr. 2, 2020

(54) Life Insurance Marketplace

(71) Applicant: Charles Sincha Huang, Lakeland, FL (US)

(72) Inventor: Charles Sincha Huang, Lakeland, FL (US)

(21) Appl. No.: 16/147,861

(22) Filed: Sep. 30, 2018

(51) Int. Cl. G06Q 40/08; G06Q 30/06; G06F 21/62; G06Q 40/06

(52) U.S. Cl. CPC G06Q 40/08; G06Q 40/06; G06F 21/6254; G06Q 30/0601

(57) ABSTRACT

The present disclosure relates to the systems and methods for a life insurance marketplace. Commonly, most people pay for their own life insurance policies. However, if someone doesn't want to pay or can't afford to pay for his own life insurance policy for whatever reason, then any benefit that a life insurance policy can provide for his family upon his death is lost. A life insurance marketplace can solve that problem by allowing other people the opportunity to pay for that insurance.

A personal user of the life insurance marketplace registers his name and profile into the marketplace. Registered personal users may also add family members to their account. The registered personal user can submit his personal and/or family account profile into the marketplace to obtain life insurance. The life insurance companies may review, deny, and/or offer competing quotes of various types of life insurance policy, policy amounts and their corresponding policy premiums to anyone in his account profile. After reviewing the competing quotes, the registered personal user can either select to keep the competing quotes private or submit any or all information into the open insurance marketplace for sale. Registered users can also be corporate users such as investment companies or hedge funds. In the life insurance marketplace, registered users, either personal or corporate can also research, browse, review, and/or compare any ownership in any life insurance policies for sale. Registered users can also transfer and/or track their life insurance ownership holdings in their personal or corporate accounts with values determined by market data. They can also buy anybody else's life insurance policies (partial or whole) for sale in the marketplace or sell any current life insurance portfolio holdings (partial or whole) at market or conditional limit orders for profit or investment diversification.

If the personal user selects to keep his and/or family life insurance quotes private, then he may purchase the selected life insurance policy (or policies) privately or do nothing. If the personal user chooses to submit his and/or family life insurance quotes into the open marketplace for sale, any other registered user(s) can review and place a bid to purchase his entire life insurance policies or a fractional amount at a market determined price. In this scenario, the insured receives a beneficiary ownership from a life insurance policy without actually paying for it.

Any selected life insurance company may accept the life insurance premiums and then issues the corresponding life insurance policies. The life insurance companies profit from the additional revenues.

After any life insurance policy is issued, a percentage amount of the beneficiary is assigned to 3 parties: the purchaser(s), the registered personal user, and the owner of the life insurance marketplace. The 3 beneficiary parties will have the right to sell their (fractional or whole) ownership in life insurance policies at any time or after a pre-determined vesting period. The 3 parties can also choose to assign their ownership to any other beneficiary including family members or significant others.

The issuing life insurance companies will also have the right to sell their life insurance policies in the life insurance marketplace to other life insurance companies of similar or higher credit ratings at any time or after a predetermined vesting period. The issuing life insurance companies will also have the right to buy their life insurance policies in the life insurance marketplace from other life insurance companies of similar or lower credit ratings at any time or after a predetermined vesting period.

One of the unique benefits as a registered personal user in the marketplace is that any personal user and his family can potentially obtain a life insurance policy without actually purchasing their own life insurance policy (or policies). Since it can essentially be free of charge, everyone should have a life insurance policy from birth to death. The life insurance companies also benefit from the additional revenues that are generated.

When the insured person dies, then the issuing life insurance company pays the policy amounts to the corresponding beneficiaries.

### SUMMARY

The present disclosure relates to the systems and methods for a life insurance marketplace. Commonly, most people pay for their own life insurance policies. However, if someone doesn't want to pay or can't afford to pay for his own life insurance policy for whatever reason, then any benefit that a life insurance policy can provide for his family upon his death is lost. A life insurance marketplace can solve that problem by allowing other people the opportunity to pay for that insurance. A personal user of the life insurance marketplace registers his name and profile into the marketplace. Registered personal users may also add family members to their account. The registered personal user can submit his personal and/or family account profile into the life insurance marketplace for life insurance companies to review. The life insurance companies may review, deny, or offer competing quotes of various types of life insurance policy, policy amounts and their corresponding policy premiums to anyone in his account profile. After reviewing the competing quotes, the registered personal user can either select to keep the competing quotes private or submit any or all information into the open insurance marketplace for sale. Registered users can also be corporate users such as investment companies or hedge funds. In the life insurance marketplace, registered users, either personal or corporate can also research, browse, review, and/or compare any ownership in any life insurance policies for sale. Registered users can also transfer and/or track their life insurance ownership holdings in their personal or corporate accounts with values determined by market data. They can also buy anybody else's life insurance policies (partial or whole) for sale in the marketplace or sell any current life insurance portfolio holdings (partial or whole) at market or conditional limit orders for profit or investment diversification. The life insurance companies also profit from the additional revenues that are generated.

### BRIEF DESCRIPTION OF THE DRAWINGS

FIG. 1 is a diagrammatic representation of an embodiment of the entire Life Insurance Marketplace.

FIG. 2 is a diagrammatic view of a flowchart depicting an embodiment of the method for a new life insurance company to enter in the Life Insurance Marketplace, and an example of the interactions of the registered life insurance company in the Life Insurance Marketplace.

FIG. 3 is a diagrammatic view of a flowchart depicting an embodiment of the method for a new user to participate in the Life Insurance Marketplace, and an example of the interactions of the registered user in the Life Insurance Marketplace.

FIG. 4 is a diagrammatic view of a flowchart depicting an embodiment where a user submits information to life insurance companies for quotes on life insurance policies, and an example of the interactions after receiving the life insurance quotes.

FIG. 5 is a diagrammatic view of a flowchart depicting an embodiment of a system where data is stored from the life insurance marketplace, users, life insurance companies, and the market data.

### DETAILED DESCRIPTION OF THE DRAWINGS

The following descriptions, example interactions and embodiments, and numerous details are set forth for the purpose of explanation. Various modifications of the example embodiments will be obvious to those who are skilled in the art of the present disclosure. The generic principles and embodiments defined herein may be applied to other applications and may be implemented without the use of the specific details without departing substantially from the spirit and principles of the invention. Therefore, it is the intent of the present disclosure to encompass the widest scope consistent with the principles and features disclosed herein.

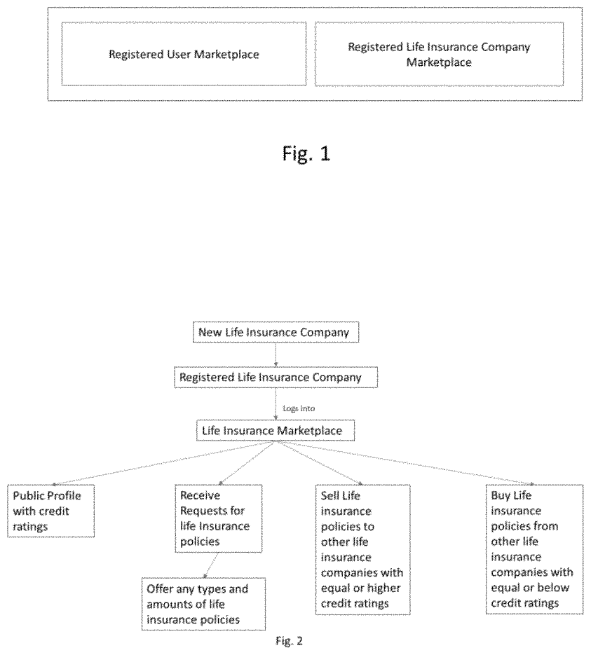

Described herein are the systems and methods for implementing a life insurance marketplace in a manner which allows a registered user marketplace and a registered life insurance company marketplace to interact together and from within. FIG. 1 illustrates a schematic diagram of the entire Life Insurance Marketplace which encompasses a Registered User Marketplace and a Registered Life Insurance Company Marketplace.

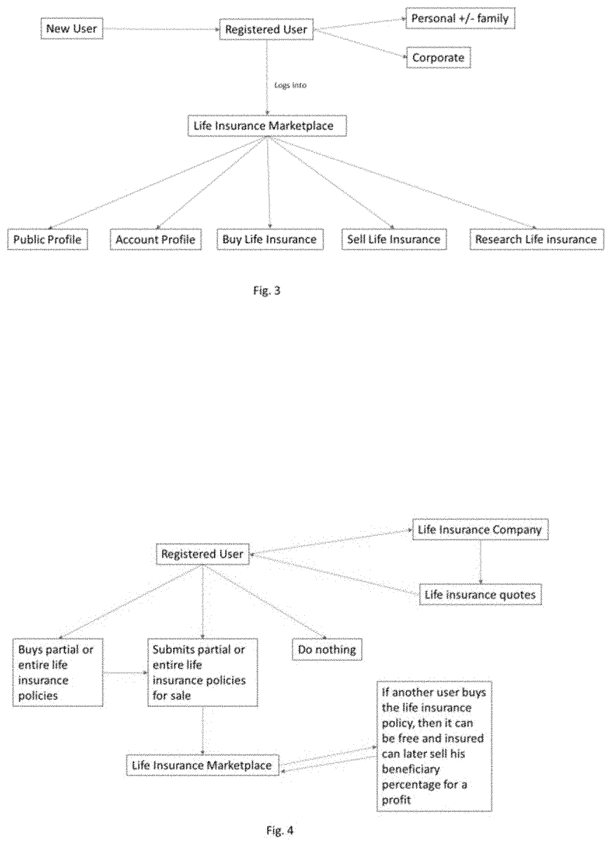

FIG. 2 is a flowchart representing an embodiment where a new life insurance company registers on the Life Insurance Marketplace. After life insurance company is authenticated, then it can log into the Life insurance Marketplace.

This flowchart also provides an embodiment where the Life Insurance Marketplace provides a public profile and a corresponding credit rating. The corresponding credit rating is commonly provided by numerous credit rating agencies.

This flowchart also provides an embodiment where the Life Insurance Marketplace allows registered users to submit requests for life insurance quotes to registered life insurance companies. Subsequently, the life insurance companies provide the costs and premiums associated with various life insurance policy types and amounts that are offered.

Life insurance companies may want to profit or diversify their life insurance holdings. This flowchart also provides an embodiment where the Life Insurance Marketplace allows registered life insurance companies to sell their issuing life insurance policies to other equal or higher credit rated companies at market or limit prices. This flowchart also provides an embodiment where the Life Insurance Marketplace allows registered life insurance companies to buy issuing life insurance policies from other equal or lower credit rated companies at market or limit prices. In this embodiment of buying and selling amongst life insurance companies, the value of the life insurance policies themselves may vary depending supply and demand amongst other market forces.

FIG. 3 is a flowchart representing an embodiment where a new user registers on the Life Insurance Marketplace. After new user is authenticated, then it can log into the Life insurance Marketplace.

This flowchart also provides an embodiment where registered users can add family members to their account. Registered users can also be corporate accounts where they represent, for example, corporations and hedge funds.

This flowchart also provides an embodiment where the Life Insurance Marketplace provides a public profile of the registered user. This public profile can also have an option to be anonymous. An account profile can also be generated from the registered user data.

Registered users may want to profit or diversify their life insurance holdings. This flowchart also provides an embodiment where the Life Insurance Marketplace allows registered users to buy or sell any partial or whole life insurance holding in themselves or in other users at market or limit prices.

This flowchart also provides an embodiment where the users can research life insurance companies, life insurance types and amounts, and any market data.

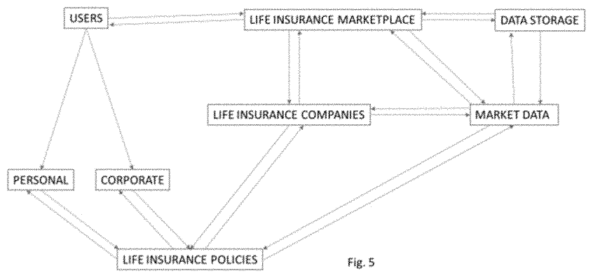

FIG. 4 is diagrammatic view of a flowchart depicting an embodiment where a user submits information to life insurance companies for quotes on his life insurance policies. Then, the user has options to either buy a partial or entire life insurance policies or submit the quotes into the Life Insurance Marketplace for sale. If another user purchases his life insurance then a percentage of the purchased benefits is assigned to the buyer, the insured, and the Life Insurance Marketplace at a pre-determined beneficiary amount. In this scenario, everyone benefits. Upon death of the insurer, the buyer, the insured, and the life insurance marketplace will receive the beneficiary amounts of the life insurance policies.

FIG. 5 is a flowchart representing an embodiment where a data storage system exchanges information with Life Insurance Marketplace, and the market data. The users and life insurance companies interact with the Life Insurance Marketplace. The users can be categorized into personal and corporate groups. The users and insurance companies can store their life insurance policy holdings in their accounts. Market data receives input from the Life Insurance Marketplace, Life insurance companies, and the corresponding life insurance policies. The value of the life insurance holdings may be affected by the Market data.

Any of the embodiments described in the present disclosure may include additional systems and methods which may not be necessarily disclosed herein but these unique disclosures will be appreciated to those of ordinary skill in the art of examining the corresponding detailed description and accompanying drawings. It is the intent of the applicant that all such embodiments, systems, and methods be included within the present disclosure and be protected by the accompanying claims.

What is claimed:

1. A method of creating a life insurance marketplace where users can research, obtain, buy, and sell various types and amounts of life insurance; life insurance companies can increase their revenues by issuing more life insurance policies; life insurance companies can buy or sell their life insurance portfolio to other life insurance companies.

2. The method of claim 1, wherein users are authenticated as registered users.

3. The method of claim 1, wherein registered users can be personal or corporate.

4. The method of claim 1, wherein personal registered users may add their family members to their account.

5. The method of claim 1, wherein life insurance companies are authenticated as registered life insurance companies.

6. The method of claim 1, wherein registered users can choose to remain anonymous in the insurance marketplace.

7. The method of claim 1, wherein registered users can provide a synopsis of their public profile.

8. The method of claim 1, wherein the life insurance marketplace provides a public profile of any registered personal user and their family.

9. The method of claim 1, wherein registered life insurance companies can provide a public profile with their verifiable credit ratings.

10. The method of claim 1, wherein the life insurance marketplace provides a public profile of any registered life insurance company.

11. The method of claim 1, wherein the life insurance marketplace will categorize life insurance companies according to their credit ratings.

12. The method of claim 1, wherein life insurance companies can offer or issue various types and amounts of life insurance policies to registered personal users and their families.

13. The method of claim 1, wherein life insurance companies can issue life insurance policies to boost their revenues.

14. The method of claim 1, wherein registered personal users may allow other registered users to purchase their life insurance policies (partial or whole) at market prices with partial or whole beneficiary ownership.

15. The method of claim 1, wherein registered users can maintain an account portfolio of life insurance policies.

16. The method of claim 1, wherein registered users can buy any life insurance holdings (partial or whole) at market or limit prices.

17. The method of claim 1, wherein registered users can sell any life insurance holdings (partial or whole) at market or limit prices.

18. The method of claim 1, wherein life insurance companies can maintain an account portfolio of life insurance policies.

19. The method of claim 1, wherein life insurance companies can sell their issuing life insurance policies to other life insurance companies of similar or higher credit ratings for risk management and/or for profit.

20. The method of claim 1, wherein life insurance companies can buy their issuing life insurance policies from other life insurance companies of similar or lower credit ratings for risk management and/or for profit.

21. The method of claim 1, wherein the life insurance marketplace can categorize and sort life insurance policies according to various risk profile ratings such as Low, Medium, or High.

22. The method of claim 1, wherein the insurance marketplace can categorize and sort available life insurance policies for sale into various insured demographics and health conditions.

23. The system of claim 1, wherein data is stored for the life insurance marketplace, all registered personal and corporate users, registered life insurance companies, life insurance policies, and market data.
